(19) United States
(12) Patent Application Publication
(10) Pub. No.: US 2017/0277006 A1
(43) Pub. Date: Sep. 28, 2017

(54) LIQUID CRYSTAL DISPLAY PANEL AND ELECTROSTATIC DISCHARGE CIRCUIT

(71) Applicant: SHENZHEN CHINA STAR OPTOELECTRONICS TECHNOLOGY CO., LTD., Shenzhen, Guangdong (CN)

(72) Inventor: Mingliang WANG, Shenzhen (CN)

(73) Assignee: SHENZHEN CHINA STAR OPTOELECTRONICS TECHNOLOGY CO., LTD., Shenzhen, Guangdong (CN)

(21) Appl. No.: 15/114,681

(22) PCT Filed: May 25, 2016
(86) PCT No.: PCT/CN2016/083323

§ 371 Date: Jul. 27, 2016

(30) Foreign Application Priority Data
Mar. 25, 2016 (CN) 201610177688.X

(51) Int. Cl. G02F 1/1362; G02F 1/133

(52) U.S. Cl. CPC G02F 1/136204; G02F 1/136286; G02F 1/13306

(57) ABSTRACT

An electrostatic discharge circuit disposed on a liquid crystal display panel, wherein the electrostatic discharge circuit includes: a ground wire disposed on a data driver of the liquid crystal display panel, wherein the ground wire is electrically grounded; and a plurality of discharge wires disposed in a display region of the liquid crystal display panel and connected to the ground wire. Further provided is a liquid crystal display panel having the electrostatic discharge circuit.

### TECHNICAL FIELD

The present disclosure relates to a circuit, and particularly, to an electrostatic discharge circuit and a liquid crystal display panel having the same.

### BACKGROUND ART

A liquid crystal display (LCD) has been in widespread usage because of its merits of light weight, thin thickness and low power consumption and so on. However, in the manufacturing process of the LCD, a defect rate caused by electrostatic discharge (ESD) damage remains at a high level, which has even been an adverse factor of the LCD ranked first.

Currently, strict anti-static measures are implemented in all of the production lines of the LCD, for example, a clean clothing and a cleanliness control are adopted with utilization of a moisturizing and ion fan, however, static electricity still threatens yield rate of production of the LCD every moment, and even threatens a life of the LCD used by a terminal user.

### SUMMARY

In order to solve the problem existing in the prior art, an aspect of the present disclosure aims to provide an ESD circuit disposed on a LCD panel, and the ESD circuit includes: a ground wire disposed on a data driver of the LCD panel, wherein the ground wire is electrically grounded; and a plurality of discharge wires disposed in a display region of the LCD panel and connected to the ground wire.

Furthermore, the plurality of discharge wires is connected to each other.

Furthermore, the ESD circuit further includes: a closed-loop wire disposed at an edge of the display region and surrounding the edge, wherein the closed-loop wire is connected to the plurality of discharge wires.

Furthermore, an extension direction of each of the discharge wires is parallel to an extension direction of data lines in the display region.

Another aspect of the present disclosure aims to provide a liquid crystal display (LCD) panel including: a display region; a data driver disposed at one side of the display region; a ground wire disposed on a data driver of the LCD panel, wherein the ground wire is electrically grounded; and a plurality of discharge wires disposed in the display region and connected to the ground wire.

Furthermore, the LCD panel further includes: a closed-loop wire disposed at an edge of the display region and surrounding the edge, wherein the closed-loop wire is connected to the plurality of discharge wires.

Furthermore, the LCD panel further includes: a plurality of data lines disposed in the display region and connected to the data driver, wherein, an extension direction of each of the discharge wires is parallel to an extension direction of the data lines.

The advantageous effects of the present disclosure are as follows: in the present disclosure, the ESD circuit covers the display region and the data drivers on the LCD panel, and is infinitely close to the gate drivers using the closed-loop wire, so that each active component and each wire on the entire LCD panel are distributed with closest ground wires (such as the closed-loop wire, the ground wire, the discharge wires and so on). Thus, when static electricity is generated, the destructive electrostatic energy may be conducted to the earth via the closest ground wires, thereby protecting electronic elements on the LCD panel.

### BRIEF DESCRIPTION OF THE DRAWINGS

The above and other aspects, features and advantages of the embodiments of the present disclosure will become apparent from the following description taken in conjunction with the accompanying drawings, in which:

FIG. 1 is a structure diagram illustrating a liquid crystal display panel according to an embodiment of the present disclosure.

FIG. 2 is a structure diagram illustrating a liquid crystal display panel configured with an electrostatic discharge circuit according to an embodiment of the present disclosure.

### DETAILED DESCRIPTION OF EXEMPLARY EMBODIMENTS

Below, the embodiment of the present disclosure will be described in details with reference to the attached drawings. The present disclosure may, however, be implemented in many different forms, and should not be construed as being limited to the specific embodiments set forth herein. Rather, these embodiments are provided for construing the principle and actual application of the present disclosure, thus those skilled in the art can understand various embodiments and modifications that are suitable for specific intended applications of the present disclosure.

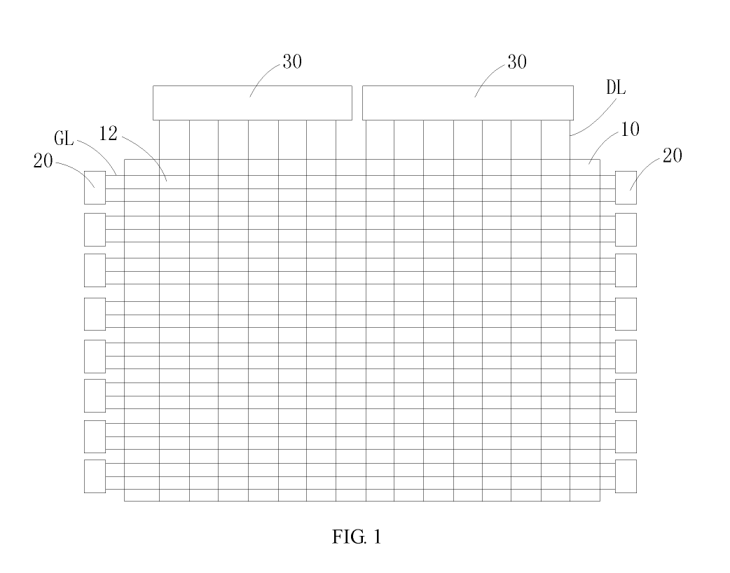

FIG. 1 is a structure diagram illustrating a liquid crystal display panel according to an embodiment of the present disclosure.

Referring to FIG. 1, the LCD panel according to an embodiment of the present disclosure includes: a plurality of data lines DL parallel to each other and a plurality of scan lines GL parallel to each other, wherein the scan lines GL are perpendicular to the data lines DL. In addition, the scan lines GL and the data lines DL divide a display region 10 of the LCD panel into a plurality of pixel regions 12. Each of the pixel regions 12 is configured with an active component (not shown in the figure), which may, for example, be a thin film transistor or other active components.

A plurality of gate drivers 20 are respectively disposed at two opposite sides of the display region 10, and two data drivers 30 are disposed at a side adjacent to the two opposite sides of the display region 10; the arrangement and the number of the gate drivers 20 and the data drivers 30 here are merely an exemplary embodiment, and the present disclosure is not limited hereto. The scan lines GL are connected to a corresponding gate driver 20 to receive a gate signal, and the data lines DL are connected to a corresponding data driver 30 to receive a data signal.

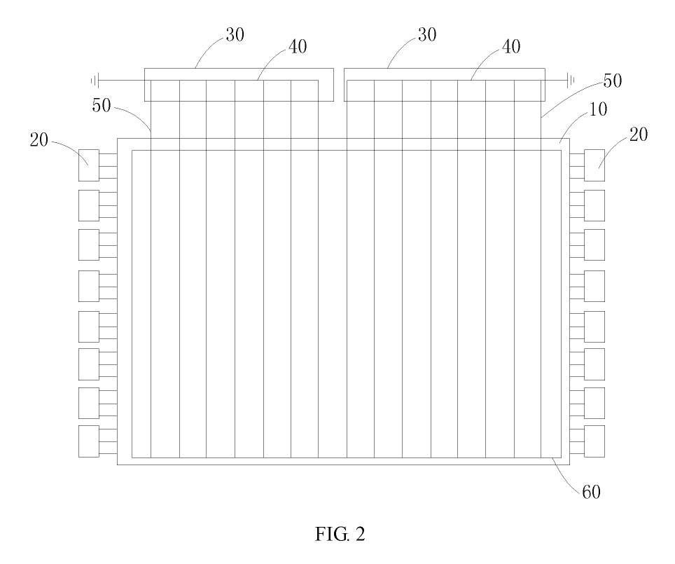

FIG. 2 is a structure diagram illustrating a liquid crystal display panel configured with an electrostatic discharge circuit according to an embodiment of the present disclosure. In FIG. 2, in order to facilitate an exhibition of the ESD circuit, the scan lines GL, the data lines DL and the pixel regions 12 are omitted.

Referring to FIGS. 1 and 2, the ESD circuit according to an embodiment of the present disclosure includes a ground wire 40 disposed on the data driver 30 and a discharge wire 50 disposed in the display region 10.

In the present embodiment, a ground wire 40 is disposed on each data driver 30 and electrically grounded. However, the number of the ground wire 40 is not limited hereto. For example, two data drivers 30 may be provided with one ground wire across the two data drivers 30.

A plurality of discharge wires 50 is disposed in the display region 10, wherein a part of discharge wires 50 is connected to one of the two ground wires 40, and the remaining part of discharge wires 50 is connected to the other one of the two ground wires 40.

Preferably, in the present embodiment, an extension direction of each of the discharge wires 50 is parallel to an extension direction of the data lines DL. However, the present disclosure is not limited hereto. For example, the extension direction of each discharge wire 50 may also be parallel to an extension direction of the scan lines GL.

Furthermore, the discharge wires 50 are all connected to each other. Specifically, the ESD circuit according to the embodiment of the present disclosure further includes a closed-loop wire 60. The closed-loop wire 60 is disposed at an edge of the display region 10 and surrounds the edge, and is connected to the plurality of discharge wires 50.

In summary, the ESD circuit according to the embodiment of the present disclosure covers the display region and the data drivers on the LCD panel, and is infinitely close to the gate drivers using the closed-loop wire, so that each active component and each wire on the entire LCD panel are distributed with closest ground wires (such as the closed-loop wire, the ground wire, the discharge wires and so on). Thus, when static electricity is generated, the destructive electrostatic energy may be conducted to the earth via the closest ground wires, thereby protecting electronic elements on the LCD panel.

Although the present disclosure has been described with reference to the specific embodiment, those skilled in the art will understand that various modifications in forms and details may be made therein without departing from the spirit and the scope of the present disclosure as defined by the appended claims and its equivalents.

What is claimed:

1. An electrostatic discharge circuit disposed on a liquid crystal display panel, comprising:
a ground wire disposed on a data driver of the liquid crystal display panel, wherein the ground wire is electrically grounded; and
a plurality of discharge wires disposed in a display region of the liquid crystal display panel and connected to the ground wire.

2. The electrostatic discharge circuit of claim 1, wherein the plurality of discharge wires are connected to each other.

3. The electrostatic discharge circuit of claim 1, wherein the electrostatic discharge circuit further comprises a closed-loop wire disposed at an edge of the display region and surrounding the edge, wherein the closed-loop wire is connected to the plurality of discharge wires.

4. The electrostatic discharge circuit of claim 2, wherein the electrostatic discharge circuit further comprises a closed-loop wire disposed at an edge of the display region and surrounding the edge, wherein the closed-loop wire is connected to the plurality of discharge wires.

5. The electrostatic discharge circuit of claim 1, wherein an extension direction of each of the discharge wires is parallel to an extension direction of data lines in the display region.

6. The electrostatic discharge circuit of claim 2, wherein an extension direction of each of the discharge wires is parallel to an extension direction of data lines in the display region.

7. The electrostatic discharge circuit of claim 3, wherein an extension direction of each of the discharge wires is parallel to an extension direction of data lines in the display region.

8. The electrostatic discharge circuit of claim 4, wherein an extension direction of each of the discharge wires is parallel to an extension direction of data lines in the display region.

9. A liquid crystal display (LCD) panel comprising:
a display region;
a data driver disposed at one side of the display region;
a ground wire disposed on the data driver, wherein the ground wire is electrically grounded; and
a plurality of discharge wires disposed in the display region and connected to the ground wire.

10. The LCD panel of claim 9, wherein the plurality of discharge wires are connected to each other.

11. The LCD panel of claim 9, wherein the LCD panel further comprises a closed-loop wire disposed at an edge of the display region and surrounding the edge, wherein the closed-loop wire is connected to the plurality of discharge wires.

12. The LCD panel of claim 10, wherein the LCD panel further comprises a closed-loop wire disposed at an edge of the display region and surrounding the edge, wherein the closed-loop wire is connected to the plurality of discharge wires.

13. The LCD panel of claim 9, wherein the LCD panel further comprises a plurality of data lines disposed in the display region and connected to the data driver, wherein, an extension direction of each of the discharge wires is parallel to an extension direction of the data lines.

14. The LCD panel of claim 10, wherein the LCD panel further comprises a plurality of data lines disposed in the display region and connected to the data driver, wherein an extension direction of each of the discharge wires is parallel to an extension direction of the data lines.

15. The LCD panel of claim 11, wherein the LCD panel further comprises a plurality of data lines disposed in the display region and connected to the data driver, wherein an extension direction of each of the discharge wires is parallel to an extension direction of the data lines.

16. The LCD panel of claim 12, wherein the LCD panel further comprises a plurality of data lines disposed in the display region and connected to the data driver, wherein an extension direction of each of the discharge wires is parallel to an extension direction of the data lines.
